(19) United States
(12) Patent Application Publication
(10) Pub. No.: US 2007/0108365 A1
(43) Pub. Date: May 17, 2007

(54) Flashlight holder

(75) Inventor: Rainer Opolka, Solingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: ZWEIBRUDER OPTOELECTRONICS GMBH

(21) Appl. No.: 11/504,795

(22) Filed: Aug. 15, 2006

(30) Foreign Application Priority Data
Nov. 16, 2005 (DE) 202005017845.4

(51) Int. Cl. F16M 13/00

(52) U.S. Cl. 248/560

(57) ABSTRACT

In combination with a flashlight having a generally cylindrical body, a holder has a ring releasably securable at least partially around the body, at least one flexible and plastically deformable elongated leg having one end fixed to the ring and an opposite end, and a magnet or suction cup at the other end of the leg for clinging to a support surface.

### FIELD OF THE INVENTION

The present invention relates to a holder. More particularly this invention concerns a holder for a flashlight.

### BACKGROUND OF THE INVENTION

A typical flashlight has an at least partially conical or cylindrical body holding one or more batteries and provided at one end with a light source. A switch on the side or end allows the source to be energized by the battery to emit light.

Such a flashlight has always been indispensable means for lighting places without a stationary electrical illumination. The disadvantage of flashlights was for a long time that the bulbs used had high power consumption that led to a quickly exhausted battery. In addition, bulbs with the incandescent filaments are sensitive to shock. Furthermore, the service life of such incandescent flashlight bulbs is limited to a small number of hours.

Light emitting diodes with an improved intensity of light can overcome most of these problems. In addition to the fact that a light emitting diode makes it possible to miniaturize the flashlight, it also is known to have a long service life as well as low power consumption, which significantly improves the practical value of the flashlight.

Light emitting diodes are also used in so-called headlamps that carry a lamp fastened to or integrated in a headband. A so-called headlamp, however, is preferably used by joggers, climbers, cavers or electricians that have to have their hands free, for instance to work on power lines in the dark with the power switched off.

Clip-on light fixtures that can be fastened to a shelf board, wall, table top or the like by means of a clamp are as well part of the state of the art. Such a clip-on light fixture is connected to a flexible arm designed like a swan's neck, at the end of which a lamp head is arranged, the light source of which is supplied by means of line voltage or a low voltage source. Such light fixtures, however, always need to be installed near a power supply socket.

### OBJECTS OF THE INVENTION

It Is therefore an object of the present invention to provide an improved holder for a light fixture.

Another object is the provision of an improved holder for a flashlight that overcomes the above-given disadvantages, in particular that allows fastening on smooth surfaces, particularly surfaces made of steel or ferrous material.

### SUMMARY OF THE INVENTION

In combination with a flashlight having a generally cylindrical body, a holder has according to the invention a ring releasably securable at least partially around the body, at least one flexible and plastically deformable elongated leg having one end fixed to the ring and an opposite end, and means at the other end of the leg for clinging to a support surface.

The advantage of such a holder consists in the fact that a flashlights that can be operated independently from the supply voltage can be detachably fastened to it without any problems. The magnets used allow fastening to metal housings of fuse boxes, heating installations, extractor hoods for fumes or vapors or suchlike. Smooth surfaces are in particular closet doors, shelf walls, window surfaces, window sills and many more. The flexible legs can be safely fastened either by means of a suction cup or by means of a magnet without further auxiliary means being required, whereby the desired orientation of the ring or partial ring in the room can be set according to the flexibility of the leg. If a flashlight is fastened within this ring, the flashlight can be aimed exactly where its light is needed. The holder can either be carried along with the flashlight as an accessory or can be permanently installed at a place where the flashlight, which is normally readily available, can be inserted in, clamped in or be otherwise fastened to the ring.

The ring or respectively the holder can also be used for holding other bodies, e.g. narrow flower vases. The holder can either consist of a closed ring enclosing the conical or cylindrical body or consist of a partial ring, extending over a partial circle periphery that is adequate to get a grip at least 180° around the conical or cylindrical body. Such partial rings should in particular be elastic, in order be able to exercise a sufficient clamping force. This is also true for full-ring bodies, insofar as the ring is directed such that the light fixture fastened thereto tensions it by its weight.

The body, preferably a flashlight, should particularly be fastened such that it is frictionally engaged in the ring, for example by inserting or clamping, or such that it is form-fittingly detachable, so that the lamp can be detached or respectively removed from the holder in a very simple manner.

According to a preferred embodiment the full-circle or partial ring engages around a cylindrical region of the housing of a flashlight. Housing portions flanking the cylindrical region have a larger diameter or bumps so that the ring is axially or longitudinally fixed on the flashlight. The gripped cylinder section is preferably formed by respective sections on the ends of parts of the flashlight, which parts are fastened to each other by means of screwthreads. Battery-powered flashlights more often than not have a battery compartment closed by a cover or end cap that can be screwed-on on the end of a cylindrical housing. If the battery compartment cover is basically designed as a cylindrical cup, its cylinder jacket is approximately of the same size or diameter as the cylindrical jacket of the rest of the flashlight housing, so that space for a full or partial ring can be created by means of a notch at the side of the groove in the area of the connection or separation point between housing and cover. The same can be achieved if the adjacent housing sections in the rest of the lamp housing as well as in the lid on the side of the jacket have a slightly larger. diameter than the inner diameter of the ring or partial ring. The surrounding areas, in particular, can have a structured, knurled or otherwise regularly or irregularly roughened surface with a larger diameter.

If the ring is composed of a solid material, for example of metal or of a plastic body, the housing with an open end at the underside can be inserted in the ring from two sides of the ring and the end cap can be inserted from the other side of the ring, whereupon the end cap and the lamp housing are screwed together. By this screwing together a stable fixation of the flashlight in the ring and thus on the holder is achieved, due to the larger diameter or the adjacent sections of the lid as well as of the housing. The ring or partial ring, however, can also consist of a molded elastic body, for example of rubber, where, according to the compressive stress with which the ring is acting on the flashlight jacket, a safe fastening can also be. guaranteed without a change in diameter of the flashlight jacket along the longitudinal axis.

According to a further embodiment of the invention the flexible legs are screwed onto the ring or partial ring. This way they can be switched for longer or shorter legs.

An optimal support or respectively cling surface is provided by such flexible legs that have a base plate at their ends to which a permanent magnet is attached. Similar to the suction cups, such base plates serve for a stable fastening of the flexible leg to a ferromagnetic surface. The same effect can also be achieved on a non-ferromagnetic thin support plate, provided that the magnet at the free end of the flexible leg is aligned with a second magnet fastened on the other side of the plate. In order to guarantee a stable holding the magnetic force has to be sufficiently strong to pass through the plate that is used.

According to a further embodiment the respective base plate is screwed on such that bigger plates and/or stronger magnets can be used. The particular advantage of the present invention consists in the fact that the holder can be fastened by means of suction cups or magnets without causing scratches or other damage to the surface to which the holder is fastened, which is not possible if clamps are used.

### BRIEF DESCRIPTION OF THE DRAWING

The above and other objects, features, and advantages will become more readily apparent from the following description, reference being made to the accompanying drawing in which:

FIG. 1 shows the holder in a schematic, perspective view;

FIG. 2 shows in side view a flashlight with the cover screwed. off;

FIG. 3 is a bottom view of a foot with a magnet

FIG. 4 shows the holder according to the invention with the flashlight fastened thereto; and

FIG. 5 is a detail view of a suction-cup foot.

### SPECIFIC DESCRIPTION

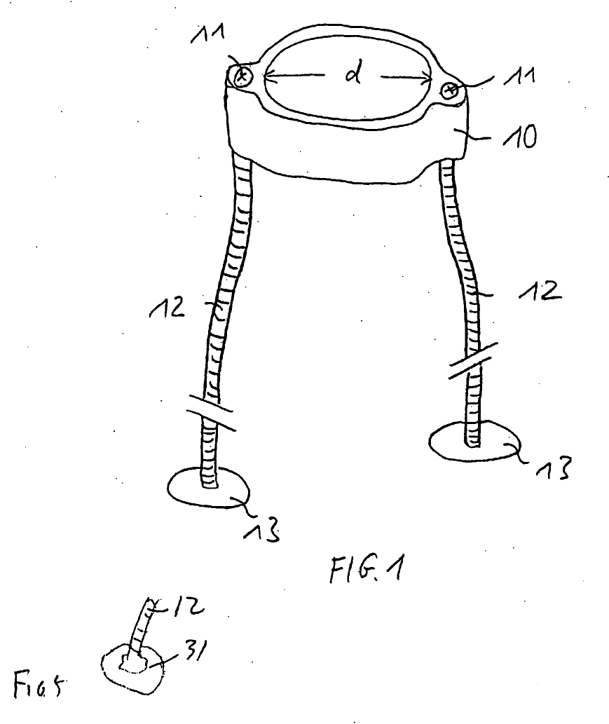

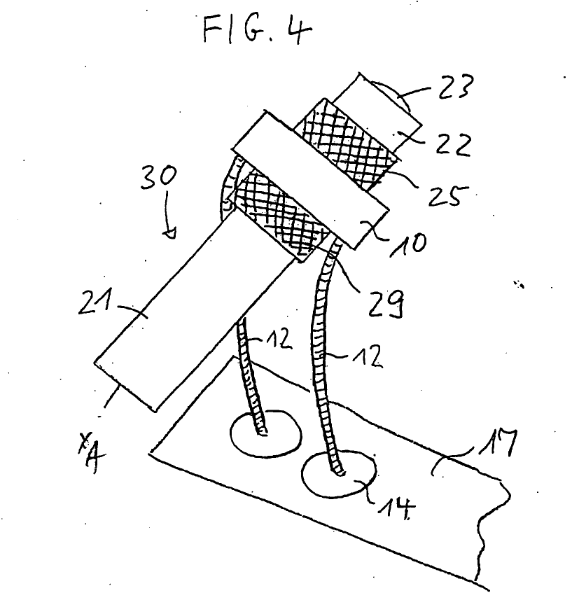

As seen in FIGS. 1 and 4 a holder basically consists of a ring 10 with an inner diameter d. Flexible legs 12 have upper ends fastened to this holder by means of screws 11 and lower ends each provided with a magnet 13 or, as shown in FIG. 5, a suction cup 31. Thanks to the magnets 13, the holder can be cling to a steel plate or other ferromagnetic support surface, which does not necessarily have to be planar, since the legs 12 are flexible and plastically deformable so they can be bent in all directions. Any conical or cylindrical bodies with a diameter larger than d in an upper region can be inserted in the inner ring opening with the diameter d.

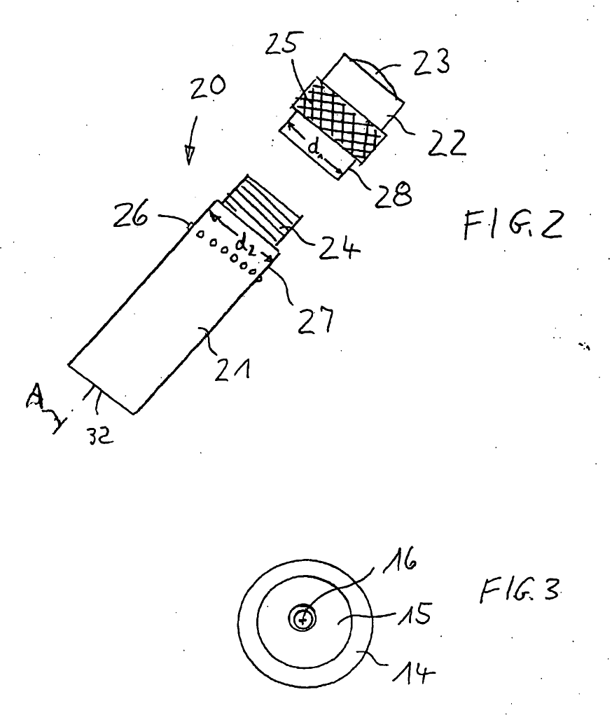

Preferably the holder displayed in FIG. 1 is used for holding a flashlight 20, shown generally in FIG. 2. This flashlight has a cylindrical housing 21, at a front side 32 of which is a light outlet. Preferably such a flashlight is provided with one or several light emitting diodes, as known in the state of the art. At the other end of the flashlight, an end cap or cover 22 is provided that in the present case also holds an on/off switch 23. This cover 22 is provided with an inner thread, into which an outer thread 24 of the flashlight body 21 can be screwed. The flashlight 20 has an annular knurled portion 25 in the cover with a diameter larger than the diameter d1 that in turn is again slightly smaller than the diameter d. Further-more, the diameter of the knurled section 25 is larger than the inner diameter d of the ring. In the front part 21 of the housing the flashlight in this embodiment has several radially projecting bumps 26 whose outermost ends define a diameter that is also larger than the inner diameter d of the ring 10. Instead. of the bumps 26, the flashlight can also be provided with a large diameter knurled portion with a diameter like that of the portion 25. The diameter d2 of the front part 21 of the flashlight is also slightly smaller than the diameter d of the ring 10, which in the present case is composed of metal or plastic.

When the lower part 21 of the flashlight 20 is inserted into the ring 10 from below and the cover 22 is inserted from above and the thread 24 is screwed into the corresponding inner thread of the cover 22, the bumps 26 and the knurling 25 form upper and lower contacts with their respective edges at the ring 10 that fits around the regions 27 and 28 such that no movement is possible, at least in the direction of the longitudinal axis A of the flashlight. If the flashlight 20 is a tight fit in the ring 10, even rotation is impossible.

This is illustrated in FIG. 4 where a flashlight 30 has knurled radially projecting portions 25 and 29 (the latter instead of the bumps 26). Otherwise, this flashlight 30 has the same construction as the flashlight according to FIG. 2.

FIG. 3 shows a bottom view of a base plate 14 to which a magnet 15 is fastened by means of a screw 16. This base plate 14 with the magnet 15 can be placed against a surface 17 as shown in FIG. 4, with the flexible legs slightly bent and the longitudinal axis A of the flashlight 30 Is tilted downward so its light is aimed at the object to be illuminated.

Instead of the magnets 13 or the base plates 14 provided with magnets 15, suction cups 31 (FIG. 5) can be used that are fitted to the flexible legs 12 at their lower ends. Such suction cups 31 that are switched for the magnets 13 or base plates 14 if necessary, allow fastening to non-ferromagnetic surfaces, such as smooth surfaces made of wood, plastic or glass.

In order to detach the flashlight according to FIG. 4, the reverse procedure is carried out, which means that the cover 22 is screwed off the flashlight housing 21 such that the two mentioned parts 21 and 22 can be removed from the ring 10. These parts 21 and 22 of the flashlight 20 can then be screwed together again and thus the flashlight 20 can be carried like a standard portable flashlight.

I claim:

1. In combination with a flashlight having a generally. cylindrical body, a holder comprising:
a ring releasably securable at least partially around the body;
at least one flexible and plastically deformable elongated leg having one end fixed to the ring and an opposite end; and
means at the other end of the leg for clinging to a support surface.

2. The holder defined in claim 1 wherein the means is a magnet.

3. The holder defined in claim 1 wherein the means is a suction cup.

4. The holder defined in claim 1 wherein the ring has a predetermined inside ring diameter and the body has a predetermined outside body diameter slightly smaller than the ring diameter.

5. The holder defined in claim 4 wherein the body has a portion of larger diameter than the ring diameter and bearing on the ring, whereby the body cannot slip completely through the ring.

6. The holder defined in claim 4 wherein the body has two spaced portions of larger diameter than the ring diameter and flanking the ring.

7. The holder defined in claim 6 wherein the body is separable between the portion.

8. The holder defined in claim 7 wherein the body has. two parts that can be threaded together and that each carry a respective one of the portions.

9. The holder defined in claim 1 wherein the ring is rigid.

10. The holder defined in claim 9 wherein the one and of the leg is screwed to the ring.

11. The holder defined in claim 1 wherein the means is screwed to the other end of the leg.

12. The holder defined in claim 1 wherein there are. two such legs diametrally opposite each other on the ring.
